(19) United States
(12) Patent Application Publication
(10) Pub. No.: US 2026/0195939 A1
(43) Pub. Date: Jul. 9, 2026

(54) METHOD, APPARATUS, DEVICE, STORAGE MEDIUM AND PRODUCT FOR PRESENTING A NODE GRAPH

(71) Applicant: Beijing Zitiao Network Technology Co., Ltd., Beijing (CN)

(72) Inventors: Yichen Wang, Beijing (CN); Shuai Zhu, Beijing (CN); Peng Dai, Beijing (CN); Yu Lu, Beijing (CN); Weirun Guo, Beijing (CN)

(21) Appl. No.: 19/441,336

(22) Filed: Jan. 6, 2026

(30) Foreign Application Priority Data
Jan. 6, 2025 (WO) PCT/CN2025/070860

(51) Int. Cl. G06T 11/26; G06F 3/04842; G06F 16/34; G06F 40/166

(52) U.S. Cl. CPC G06T 11/26; G06F 3/04842; G06F 16/345; G06F 40/166; G06T 2200/24

(57) ABSTRACT

Embodiment of the disclosure relates to a method, an apparatus, a device, a storage medium, and a product for presenting a node graph. The method includes: presenting a node graph and a plurality of selectable layout patterns in a page, the node graph comprising a work node having a connection relationship, and the work node being configured to perform a corresponding function based on corresponding configuration information a; and in response to selection of a first layout pattern from the plurality of selectable layout patterns, arranging the work node in the node graph according to the first layout pattern, where in the first layout pattern, detailed information of the work node is presented, and detailed information the work node comprises an editable item.

### CROSS-REFERENCE

This application claims priority to Internation Application No. PCT/CN2025/070860, filed on Jan. 6, 2025, and entitled ‘METHOD, APPARATUS, DEVICE, STORAGE MEDIUM AND PRODUCT FOR PRESENTING A NODE GRAPH’, which is incorporated herein by reference in its entirety.

### FIELD

Embodiments of the present disclosure relate to the field of computer technologies, and in particular, to a method, apparatus, device, storage medium, and product for presenting a node graph.

### BACKGROUND

Currently, in order to facilitate management of a business process, a user may describe those functions or tasks associated with each other in a business process by means of a node graph. For example, the node graph may include several nodes, and each node may correspond to one function or task in the business process. In this way, through the connection relationship between the nodes in the node graph, the user may intuitively see the logical relationship and the execution sequence between functions or tasks in the service process. This visual representation helps the user better arrange and understand business processes.

### SUMMARY

In a first aspect of the present disclosure, a method for presenting a node graph is provided. The method includes: presenting a node graph and a plurality of selectable layout patterns in a page, the node graph including at least one work node having a connection relationship, and a work node in the at least one work node being configured to perform a corresponding function based on corresponding configuration information; and in response to selection of a first layout pattern from the plurality of layout patterns, arranging the at least one work node of the node graph according to the first layout pattern, wherein in the first layout pattern, detailed information of the at least one work node is presented, and detailed information of one or more work nodes of the at least one work node includes at least one editable item.

In a second aspect of the present disclosure, an apparatus for presenting a node graph is provided. The apparatus includes: a presenting module configured to present a node graph and a plurality of selectable layout patterns in a page, the node graph including at least one work node having a connection relationship, and a work node in the at least one work node being configured to perform a corresponding function based on corresponding configuration information; and an arranging module configured to, in response to selection of a first layout pattern from the plurality of layout patterns, arrange the at least one work node of the node graph according to the first layout pattern, wherein in the first layout pattern, detailed information of the at least one work node is presented, and detailed information of one or more work nodes of the at least one work node includes at least one editable item.

In a third aspect of the present disclosure, an electronic device is provided. The device includes: at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer readable storage medium has computer-executable instructions stored thereon, the computer-executable instructions being executable by a processor to implement the method of the first aspect.

In a fifth aspect of the present disclosure, a computer program product is provided. The computer program product includes computer-executable instructions, the computer-executable instructions, when executed by a processor, implementing the method of the first aspect of the present disclosure.

It would be appreciated that the content described in this content section is not intended to limit the key features or important features of the embodiments of the present disclosure, nor is it intended to limit the scope of the present disclosure. Other features of the present disclosure would become readily understood from the following description.

### BRIEF DESCRIPTION OF DRAWINGS

The above and other features, advantages, and aspects of various embodiments of the present disclosure would become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 illustrates a schematic diagram of an example of a first layout pattern according to some embodiments of the present disclosure;

FIG. 3 illustrates a schematic diagram of an example of detailed information according to some embodiments of the present disclosure;

FIG. 4 illustrates a schematic diagram of an example of a second layout pattern according to some embodiments of the present disclosure;

FIG. 5A illustrates a schematic diagram of an example of a plurality of work nodes interconnected in a second layout pattern according to some embodiments of the present disclosure;

FIG. 5B illustrates a schematic diagram of an example of a plurality of work nodes interconnected in a first layout pattern according to some embodiments of the present disclosure;

FIG. 6A illustrates a schematic diagram of an example of two work nodes interconnected in a second layout pattern according to some embodiments of the present disclosure;

FIG. 6B illustrates a schematic diagram of an example of two work nodes interconnected in a first layout pattern according to some embodiments of the present disclosure;

FIG. 7A illustrates a schematic diagram of an example of a plurality of work nodes before automatic layout in a second layout pattern according to some embodiments of the present disclosure;

FIG. 7B illustrates a schematic diagram of an example of a plurality of work nodes after automatic layout in a second layout pattern according to some embodiments of the present disclosure;

FIG. 8A illustrates a schematic diagram of an example of a plurality of work nodes before automatic layout in a first layout pattern according to some embodiments of the present disclosure;

FIG. 8B illustrates a schematic diagram of an example of a plurality of work nodes after automatic layout in a first layout pattern according to some embodiments of the present disclosure;

FIG. 9 shows a flowchart of an example process of a method for presenting a node graph according to some embodiments of the present disclosure;

FIG. 10 shows a schematic structural block diagram of an apparatus for presenting a node graph according to some embodiments of the present disclosure; and

FIG. 11 illustrates a block diagram of an electronic device in which one or more embodiments of the present disclosure may be implemented.

### DETAILED DESCRIPTION

Embodiments of the present disclosure would be described in more detail below with reference to the accompanying drawings. While certain embodiments of the present disclosure are shown in the accompanying drawings, it would be understood that the present disclosure may be implemented in various forms and would not be construed as limited to the embodiments set forth herein. Rather, these embodiments are provided for a more thorough and complete understanding of the present disclosure. It would be understood that the drawings and embodiments of the present disclosure are for example purposes only and are not intended to limit the scope of the present disclosure.

It would be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

As briefly described above, through the node diagram, the user may intuitively see the logical relationship and execution sequence between functions or tasks in the service process. As an example, a node graph includes a series of interconnected work nodes, and each work node may correspond to at least one function in a service process. The connection relationships between work nodes represent logical relationships and execution orders between work nodes. Through the connection relationship between the work nodes, the user may clearly see how the functions in the service process are related to each other, and their execution order. When arranging the node graph, the user may flexibly configure functions corresponding to different work nodes and a connection relationship between the work nodes.

Currently, a relatively fixed manner is used to present a node graph. In this presentation manner, the user may not directly view detailed information of each work node in the node graph, but needs to trigger display of these detailed information through additional interaction operations. To obtain or modify detailed information of a work node, the user must perform a direct interaction operation with a corresponding work node in the node graph. Such an operation may be, for example, a mouse click, touch, or other form of user input.

After the user clicks on or selects a work node, the system, in response to this action, triggers an editing interface pop-up containing an editing option. The editing interface includes a detailed information presentation area and an editing option. The detailed information presentation area is configured to display detailed information of the current work node, such as a name, a description, an executor, an expiration date, and the like. The editing option provides a series of tools or controls, allowing the user to modify detailed information of the work node, etc.

Although this fixed node diagram presentation manner meets the basic requirement of the user on the node graph management to a certain extent, the user needs to click the work node one by one to view or modify the detailed information, which may become very tedious when the work node is relatively large, thereby affecting the user experience.

In view of this, the embodiments of the present disclosure provide a solution for presenting a node graph. According to the solution, firstly, a node graph and a plurality of selectable layout patterns are presented in a page, the node graph including at least one work node having a connection relationship, and a work node in the at least one work node being configured to perform a corresponding function based on corresponding configuration information. Then, in response to selection of a first layout pattern from the plurality of layout patterns, the at least one work node of the node graph is arranged according to the first layout pattern, wherein in the first layout pattern, detailed information of the at least one work node is presented, and detailed information of one or more work nodes of the at least one work node includes at least one editable item.

As would be more clearly understood from the following description, aspects of the present disclosure allow a user to select a plurality of layout patterns directly in a page to view a node graph and, when selecting a particular layout pattern (e.g., a first layout pattern), detailed information for all work nodes is automatically displayed. This intuitive way of presentation reduces the interactive operation of the user (e.g., the user does not need to click the work node one by one), and makes the overall structure of the node graph and the state of each work node clear. In addition, the detailed information of at least one work node includes an editable item, so that the user may directly edit the information that needs to be modified in the page without entering an additional editing interface, thereby improving convenience and efficiency of the edit operation.

In this way, by introducing various layout patterns and directly presenting detailed information and editable items of the work node in a specific layout pattern, the solution provided by the present disclosure significantly improves user experience and improves management efficiency of the node graph.

A diversified layout pattern is provided for user selection, detailed information of all work nodes may be directly presented in a specific layout pattern, and user experience and working efficiency are greatly improved.

Various example implementations of this solution would be described in detail below in conjunction with the accompanying drawings.

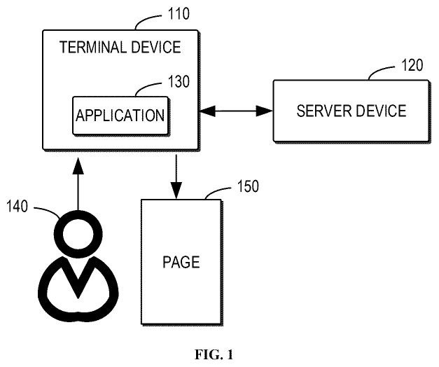

FIG. 1 illustrates a schematic diagram of an example environment 100 in which embodiments of the present disclosure may be implemented. Referring to FIG. 1, the example environment 100 may include a terminal device 110 and a server device 120.

In the example environment 100, an application 130 for arranging a node graph is installed in the terminal device 110. A user 140 may interact with the application 130 via the terminal device 110 and/or its attachment device to enable operations such as viewing or editing of the node graph. In some embodiments, the terminal device 110 may present a page 150 of the application 130, which may be presented in the page 150 for viewing by the user 140. In addition, the user 140 may add, delete or adjust a work node in the node graph through the page 150, to edit the node graph.

In some embodiments, the terminal device 110 communicates with the server device 120 to implement provisioning of the application 130. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a ‘wearable’ circuit, etc.).

The server device 120 may be a standalone physical server, a server cluster composed of a plurality of physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 120 may include, for example, a computing system/server, such as a mainframe, an edge computing node, a computing device in a cloud environment, or the like. The server device 120 may provide a background service for an application 130 that supports content presentation in the terminal device 110.

A communication connection may be established between the server device 120 and the terminal device 110. The communication connection may be established in a wired manner or a wireless manner. Communication connections may include, but are not limited to, Bluetooth connections, mobile network connections, universal serial bus connections, wireless fidelity connections, etc., the embodiments of the present disclosure are not limited in this respect. In an embodiment of the present disclosure, the server device 120 and the terminal device 110 may implement signaling interaction by using a communication connection between the server device 120 and the terminal device 110.

It would be appreciated that the structures and functions of the various elements in the environment 100 are described for example purposes only and do not imply any limitation to the scope of the present disclosure.

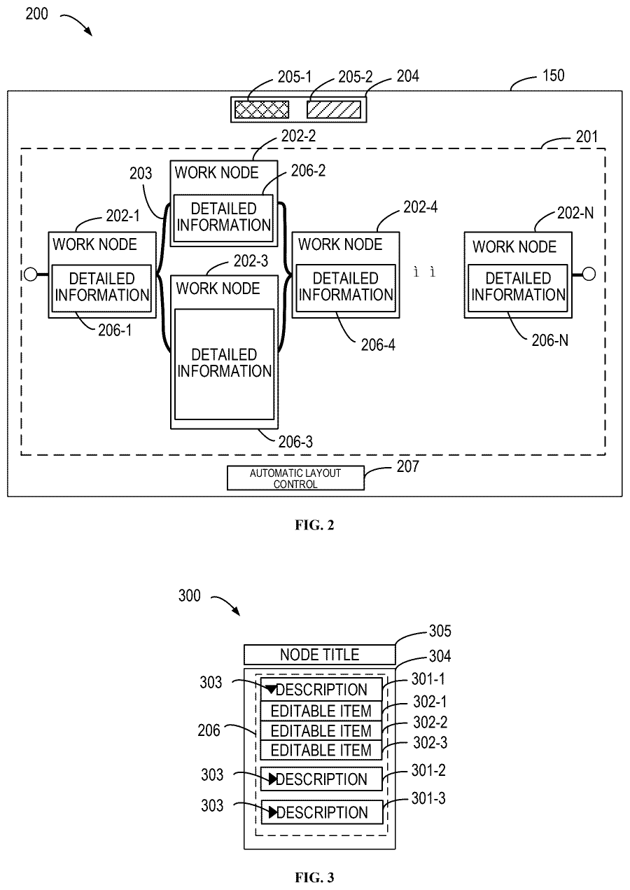

FIG. 2 illustrates a schematic diagram of an example 200 of a first layout pattern according to some embodiments of the present disclosure. A method for presenting a node diagram according to an embodiment of the present disclosure would be described below with reference to FIG. 1 and FIG. 2.

The terminal device 110 presents a node graph 201 and a plurality of selectable layout patterns in the page 150, the node graph 201 includes at least one work node having a connection relationship, and a work node in the at least one work node being configured to perform a corresponding function based on corresponding configuration information.

For ease of description, in the example 200, the node diagram 201 is shown, which includes N work nodes 202-1, 202-2, 202-3, 202-4, . . . , 202-N, where N is an integer greater than or equal to 1. According to actual needs, the node diagram 201 may further include more work nodes, and the connection relationship between these work nodes is not limited to the form shown in FIG. 2. It would also be noted that, for clarity of description, the work nodes 202-1, 202-2, 202-3, 202-4, . . . , 202-N are also referred to individually or collectively as the work nodes 202. The node graph 201 may visually present the relationships between the respective work nodes 202 in a visualized form. In practical applications, such a node graph 201 is sometimes also referred to as a workflow, workflow, node relationship graph, node connection graph, or the like.

The terminal device 110 may, in response to a predetermined operation of the user 140, load and render the node graph 201. Alternatively or in addition, the terminal device 110 may load and present the node graph 201 according to the editing or viewing request of the user 140. The node graph 201 may be an edited node graph or a node graph that is being edited. This is not limited to the embodiments of the present disclosure.

As an example, the node graph 201 may correspond to one business process, and each work node 202 in the node graph 201 may correspond to at least one function in the business process. The connection relationship between the plurality of work nodes 202 is configured to indicate a logical relationship or an execution sequence between corresponding functions. As an example, the connection relationship between the plurality of work nodes 202 may be presented in a graphical manner. For example, in example 200, the connection relationship between the plurality of work nodes 202 is represented with a connection line 203. In addition, according to actual needs, the connection relationship between the plurality of work nodes 202 may also be represented by an arrow or other visual elements, which is not limited to the embodiments of the present disclosure. The plurality of work nodes 202 are connected in series or in parallel through a connection relationship to form a complete and ordered business process.

Each configurable item in the configuration information of the work node may be determined based on the type of work node, and each configurable item may correspond to one or more editable items for editing by the user. As an example, the configurable item of the configuration information of each work node may include a type, an attribute, or other related settings of the work node. The configuration information determines the behavior and function of the work node in the node graph. These functions may be functions corresponding to the work node in the business process. For example, these functions include, but are not limited to, data processing, information transmission, computation, control, or any other type of functionality.

In an embodiment of the present disclosure, a plurality of layout patterns applicable to the node graph may also be presented while the node graph is presented. As shown in FIG. 2, the terminal device 110 may present a layout switching control 204 on the page 150. The user 140 may trigger a switch between a plurality of layout patterns by operating the layout switching control 204. In the example 200, the layout switching control 204 is shown as a tab page and the layout switching control 204 includes tabs 205-1 and 205-2 respectively corresponding to the plurality of layout patterns. The user 140 selects the tag 205-1 or 205-2 to enable switching between a plurality of layout patterns. For example, the user 140 switches to the layout pattern (hereinafter sometimes referred to as the first layout pattern) corresponding to the tag 205-1 by selecting the tag 205-1, and switches to the layout pattern (hereinafter sometimes referred to as the second layout pattern) corresponding to the tag 205-2 by selecting the tag 205-2.

It would be noted that, for clarity, in the example 200, the layout switching control 204 including the two tags 205-1 or 205-2 is shown, and according to the number of layout patterns, the layout switching control 204 may further include more tags, which is not limited in the embodiments of the present disclosure. In addition, according to actual requirements, the layout switching control 204 may also be presented in other forms. For example, the layout switching control 204 may also be presented through a drop-down menu, button group, or other form of interactive element.

In different layout patterns of the plurality of layout patterns, the work nodes in the work node 202 may be arranged in different manners. In addition, in different layout patterns of the plurality of layout patterns, the amount of information presented by each work node 202 is different. In an embodiment of the present disclosure, the plurality of layout patterns includes at least a first layout pattern. The terminal device 110, in response to selection of the first layout pattern from the plurality of layout patterns, arranges the at least one work node 202 of the node graph 201 according to the first layout pattern. In the first layout pattern, detailed information of at least one work node 202 is presented, and detailed information of one or more work nodes 202 of the at least one work node 202 includes at least one editable item.

In the example 200, assume that the first layout pattern (i.e., the layout pattern corresponding to the tag 205-1) is selected, thus presenting detailed information 206-1, 206-2, 206-3, 206-4, . . . , 206-N of the work nodes 202-1, 202-2, 202-3, 202-4, . . . , 202-N in the page 150. For clarity, the detailed information 206-1, 206-2, 206-3, 206-4, . . . , 206-N is also referred to individually or collectively as detailed information 206.

The detailed information 206 of each work node 202 may include at least one description of the configuration information for the work node 202. In addition to the types, attributes, etc. described above, the configurable item of the configuration information for each work node 202 may also include input information (one or more input parameters), output information (one or more output parameters) of the work node 202, and processing information (one or more processing parameters) for the input information. The information is editable (e.g., edited by one or more editable items) by a user. FIG. 3 shows a schematic diagram of an example 300 of detailed information according to some embodiments of the present disclosure. Referring to FIG. 3, the detailed information 206 includes a plurality of descriptions 301-1, 301-2, and 301-3 for the work node 202, which are also individually or collectively referred to as descriptions 301, for clarity of presentation. As an example, the description 301-1 may be a description of input information for the work node 202, the description 301-2 may be a description of output information for the work node 202, and the description 301-3 may be a description of the processing information for the work node 202. It would be noted that the foregoing description about the description 301 is merely an example description, and the detailed information 206 may further include more descriptions according to actual needs.

In an embodiment of the present disclosure, in the first layout pattern, the terminal device 110 may directly present the detailed information 206 of all the work nodes 202. In the case that the user 140 faces the complex node graph 201 containing a large number of work nodes 202, the presentation described above enables the user 140 to simultaneously browse the full appearance of the node graph 201 and the detailed information 206 for each work node 202. This process does not require the user 140 to click on the work node 202 one by one, thereby saving the operation of the user 140.

In the first layout pattern, the presented detailed information 206 also includes at least one editable item for editing one or more information items of the detailed information. Based on the at least one editable item, the user 140 may not only view the detailed information 206 of the work node 202 but also edit or modify the work node 202 directly in the current view.

In some embodiments, in the first layout pattern, for a given work node of the at least one work node 202, in response to receiving an edit operation on the editable item of the given work node, the terminal device 110 updates the detailed information 206 of the given work node based on the edit operation. The terminal device 110 then presents the updated detailed information 206 for the given work node.

As an example, a given work node may refer to any of the at least one work node 202. If the user 140 browses a certain work node 202 in the first layout pattern, it is found that when some pieces of detailed information 206 of the work node 202 (for example, some description for the work node 202) needs to be adjusted or updated, the user 140 does not need to perform additional operations to jump to a further interface or operation pop-up editing interface, but may directly perform an edit operation on the editable item presented by the work node 202 in the first layout pattern. As an example, an editable item may be presented in an intuitive manner. For example, the editable item in the detailed information 206 may be presented through a text box, a drop-down menu, and a check box, so that the user 140 may easily perform an edit operation. As an example, the edit operation may include adding, deleting or modifying the detailed information 206, depending on the type of the editable item and the service requirement of the work node 202, which would not be enumerated herein.

Once the update is complete, the terminal device 110 may immediately present the updated detailed information 206 for the given work node. This means that the user 140 may immediately see the result of the edit operation without leaving the current view. This instant feedback mechanism not only enhances the operation experience of the user 140 but also improves the working efficiency because the user 140 may continuously edit and adjust without waiting for the page 150 to refresh or jump.

As an example, the detailed information 206 of the work node 202 includes a plurality of editable items, at least some of which are associated with the same description 301, and different editable items are associated with different descriptions 301. For each editable item, the editable item is configured to edit the description 301 associated therewith. With continued reference to FIG. 3, in the same work node 202, the detailed information 206 may include a plurality of editable items 302-1, 302-2, and 302-3, which are also individually or collectively referred to as editable items 302 for clarity of presentation. In the example 300, the editable items 302-1, 302-2, and 302-3 are associated with the description 301-1 and are configured to edit the description 301-1. It would be noted that, for clarity of illustration, only the editable item 302 associated with the description 301-1 is shown in the example 300, and in an actual application, the description 301-2 and the description 301-2 may also be associated with at least one editable item 302. As an example, each description 301 is provided with a folding control 303 configured to control the folding of the editable item 302 associated with the corresponding description 301, so as to present or hide the editable item 302 associated with the description 301 according to actual needs. It would be noted that the above description about the editable item 302 is merely an example description, and each description 301 may be associated with more editable items 302 according to actual needs.

In some embodiments, in the first layout pattern, at least one work node 202 is each configured with a corresponding information presentation area in which the detailed information 206 of the at least one work node 202 is presented. For a given work node in the at least one work node 202, the terminal device 110 determines a size of the information presentation area corresponding to the given work node based on at least one of the following: a presentation size requirement of the detailed information 206 of the given work node, and an upper size limit of the information presentation area. Then, the terminal device 110 presents the detailed information 206 of the given work node in the information presentation area with the determined size.

With continued reference to FIG. 3, a position of an information presentation area 304 is associated with a corresponding work node 202. In the example 300, the information presentation area 304 is presented below a node title 305 of the corresponding work node 202. In addition, the information presentation area 304 may also be presented elsewhere, according to actual needs. For example, the information presentation area 304 may also be presented on the left and right sides of the node title 305 of the corresponding work node 202.

The presentation size requirement here may refer to an ideal size required to present the detailed information 206. In some embodiments, the presentation size requirement may be determined based on an amount of information of the detailed information 206 and/or the type of information of the detailed information 206, etc. For example, where the detailed information 206 contains a large amount of information, a larger presentation size is required to present the detailed information 206.

The upper size limit here may refer to a maximum size that the information presentation area 304 may occupy on the page 150. In some embodiments, the upper size limit may be determined based on layout requirements of the page 150, etc. For example, to maintain balance of the overall page 150 layout, the information presentation area 304 may need to maintain a certain scale and spacing with other elements in the page 150 or the information presentation area 304 of other work nodes 202, thereby limiting its upper size limit.

In some embodiments, the terminal device 110 may determine the size of the information presentation area 304 based on the presentation size requirement of the detailed information 206. In this case, the terminal device 110 may determine the size of the information presentation area 304 based on the information amount of the detailed information 206 and/or the information type of the detailed information 206, to ensure that the detailed information 206 may be completely presented in the information presentation area 304.

In some embodiments, the terminal device 110 may determine the size of the information presentation area 304 based on an upper size limit of the information presentation area 304. In this case, the terminal device 110 may evaluate the available space on the page 150 and the positional relationship with other elements or other work nodes 202 on the page 150, so as to set the maximum size of one information presentation area 304. Then, the terminal device 110 may unify the sizes of the presentation areas of all the work nodes 202, thereby ensuring the cleanliness and ease of use of the page.

In some embodiments, the above presentation size requirement and size upper limit may be considered at the same time to find an optimal balance point. For example, the terminal device 110 first calculates an initial size of the information presentation area 304 based on the information amount of the detailed information 206 and/or the information type of the detailed information 206. Then, the terminal device 110 compares the initial size with the upper size limit of the information presentation area 304. If the initial size does not exceed the upper size limit of the information presentation area 304, the terminal device 110 may determine the initial size as the final size of the information presentation area 304, so that the information presentation area 304 may completely present all the detailed information presentation 206. If the initial size exceeds the upper size limit of the information presentation area 304, the terminal device 110 may determine the upper size limit as a final size of the information presentation area 304. In some embodiments, for the part that the detailed information 206 fails to be presented, the terminal device 110 may correspondingly set a scroll control or the like on the information presentation area 304, so that the user 140 may scroll the detailed information 206 in the information presentation area 304 by operating the scroll control.

In this way, the terminal device 110 may provide optimal information presentation experience for the user 140 in different situations, thereby meeting different information presentation requirements.

In some embodiments, the terminal device 110, in response to selection of a second layout pattern of the plurality of layout patterns, arranges the at least one work node 202 of the node graph 201 according to the second layout pattern. In the second layout pattern, summary information of each of the at least one work node 202 is presented.

As previously described, the user 140 may switch to the second layout pattern by selecting the tab 205-2. FIG. 4 illustrates a schematic diagram of an example 400 of the second layout pattern (i.e., a layout pattern corresponding to the tag 205-2) according to some embodiments of the present disclosure. Referring to FIG. 4, in the second layout pattern, the terminal device 110 no longer causes each work node 202 to present the detailed information 206 as in the first layout pattern, but a more concise and generalized display mode is adopted. Specifically, in the example 400, assuming the second layout pattern is selected, summary information 401-1, 401-2, 401-3, 401-4, . . . , 401-N of the respective work nodes 202-1, 202-2, 202-3, 202-4, . . . , 202-N is presented in the page 150. For clarity, the summary information 401-1, 401-2, 401-3, 401-4, . . . , 401-N is also referred to individually or collectively as summary information 401.

In some embodiments, the summary information 401 may be a simplification and refinement of the detailed information 206 of the work node 202. The summary information 401 is intended to provide a quick overview for the user 140. For example, the summary information 401 may include, but is not limited to, a node name of the work node 202 or any short description or tab for the work node 202. This summary information 401 helps the user 140 to quickly know the profile of the work node 202.

It would be noted that, in addition to the first layout pattern and the second layout pattern described above, according to actual requirements, the plurality of layout patterns may further include more layout patterns. For example, the plurality of layout patterns may further include layout patterns for changing the arrangement structure of the work nodes. Such a layout pattern may include, for example, a linear layout, a tree layout, a grid layout, and the like, and the embodiments of the present disclosure are not enumerated herein.

In some embodiments, in the second layout pattern, for a given one of the at least one the work node 202, the terminal device 110 may present the detailed information 206 of the given work node based on a predetermined operation on the summary information 401 of the given work node. In some embodiments, the terminal device 110 presents the detailed information 206 for a given work node in a further area different from the presentation area of the node graph 201.

The predetermined operations herein include, but are not limited to, a click operation, a hover operation, and a long-press operation. After the user 140 performs the predetermined operation, the terminal device 110 may present the detailed information 206 of the given work node by opening a new window, tab page, or popping a sidebar. That is, in the second layout pattern, if the detailed information of the work node is to be viewed, the presentation of the detailed information needs to be triggered by additional operations, and a separate interface needs to be provided to present the detailed information.

With continued reference to FIG. 4, in response to a predetermined operation of the user 140, the terminal device 110 may pop up the sidebar 402. The sidebar 402 is configured to present the detailed information 206 of the work node 202, while also maintaining independence and integrity of the original node graph 201 view. In addition, the terminal device 110 may also present the detailed information 206 for a given work node in a different manner than that described above. For example, the terminal device 110 may further expand a larger area at an original position or an adjacent position of the work node 202, and is configured to display the detailed information 206 of the work node 202.

As previously described, the detailed information 206 may include at least one description 301 for the work node 202 and the editable item 302 associated with the description 301, and the editable item 302 associated with the description 301 may be presented in the description presentation area 403 of the sidebar 402. For clarity of illustration, FIG. 4 only shows the description 301-1 and the editable items 302-1, 302-2, and 302-3 associated with the description 301-1 in the description presentation area 403. According to actual needs, more descriptions 301 may also be presented in the presentation area 403, which is not limited in the embodiments of the present disclosure.

As an example, the sidebar 402 may include a description switching control 404. The user 140 may control the description 301 and the editable item 302 presented in the presentation area 403 by describing the switching control 204. In the example 400, the description switch control 404 is shown as a tab page, and the description switch control 404 includes tabs 405-1, 405-2, and 405-3 respectively corresponding to the plurality of descriptions 301-1, 301-2, and 301-3. The user 140 controls the description 301 and the editable item 302 presented in the presentation area 403 by selecting the tags 405-1, 405-2, or 405-3. For example, the user 140 controls the description presentation area 403 to present the description 301-1 corresponding to the tab 405-1 and the editable items 302-1, 302-2, and 302-3 associated with the description 301-1 by selecting the tab 405-1.

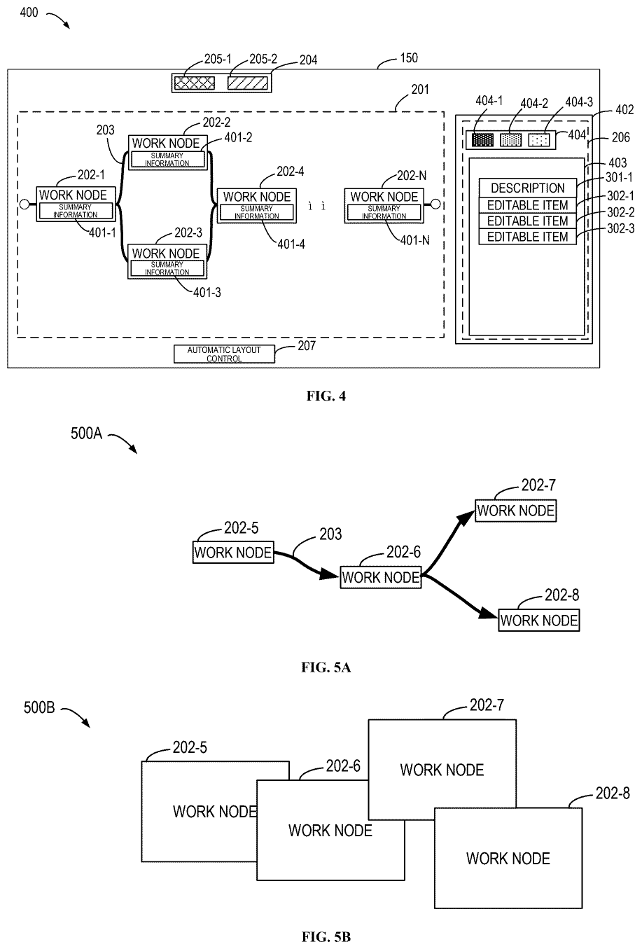

FIG. 5A shows a schematic diagram of an example 500A of a plurality of work nodes 202 interconnected in a second layout pattern according to some embodiments of the present disclosure, and FIG. 5B shows a schematic diagram of an example 500B of a plurality of work nodes 202 interconnected in a first layout pattern according to some embodiments of the present disclosure. It would be noted that, for clarity, FIG. 5A and FIG. 5B show the work nodes 202-5 to 202-8 in the plurality of work nodes 202-1, 202-2, 202-3, 202-4, . . . , 202-N. However, in the embodiments of the present disclosure, the interconnected plurality of work nodes 202 are not limited thereto, and the interconnected plurality of work nodes 202 may be any plurality of work nodes 202 connected together in the plurality of work nodes 202-1, 202-2, 202-3, 202-4, . . . , 202-.

With reference to FIG. 5A and FIG. 5B, in the first layout pattern and the second layout pattern, since the information amount of the information presented by the work node 202 is different, in the two layout patterns, the work node 202 has different sizes. Specifically, in the second layout pattern, the work node 202-5 and the work node 202-6 need only present the summary information 401 described above. Therefore, the size of the work node 202 is small. In the first layout pattern, the work node 202-5 and the work node 202-6 need to present the detailed information 206 described above, and therefore, the size of the work node 202 is large. When the terminal device 110 is switched from the second layout pattern to the first layout pattern, since the size of the work node 202 becomes larger, it may cause the work node 202 to generate the overlapping situation as shown in FIG. 5B. In order to make the size of the work node 202 larger without causing the work node 202 to overlap, in some embodiments, the terminal device 110, in response to switching from one of the plurality of layout patterns to a further layout pattern, controls the relative positioning between the two work nodes 202 interconnected in the node diagram 201 to maintain unchanged.

As an example, the two interconnected work nodes 202 may refer to any two work nodes 202 connected together by a connection line 203 (which may also be a further connection element). For example, with continued reference to FIG. 5A and FIG. 5B, the two interconnected work nodes 202 may refer to the work node 202-5 and the work node 202-6 connected together by a connection line 203, or may refer to the work node 202-6 and the work node 202-7 connected together by a connection line 203, and so on, and the embodiments of the present disclosure are not listed one by one. It would be noted that the connection line 203 may include an ‘arrow’ indicating that the work node 202 executes the sequence, and for the sake of clarity, some drawings (such as FIG. 2 and FIG. 4) of the embodiments of the present disclosure steal the ‘arrow’.

As an example, the relative positioning between the two interconnected work nodes 202 may maintain unchanged, which means that when the terminal device 110 performs layout pattern switching (for example, switching from the first layout pattern to the second layout pattern, or switching from the second layout pattern to the first layout pattern), the relative distance and/or the relative direction of the two work nodes 202 interconnected in the node diagram 201 may not change. This means that regardless of how the user 140 switches the layout pattern, the relative positioning of the two work nodes 202 on the page 150 maintain stable and would not change due to changes in the layout pattern. This ensures that the work nodes may still maintain a relatively reasonable arrangement manner when switching in the layout pattern, and do not overlap with each other.

In some embodiments, the terminal device 110 determines a start point and an end point of the connection line 203 between the two work nodes 202 interconnected in the node diagram 201 before the switching. Then, the terminal device 110 controls the relative positioning between the start point and the end point of the connection line 203 to maintain unchanged after the switching, to maintain the relative positioning between the two work nodes 202 interconnected in the node graph 201 unchanged.

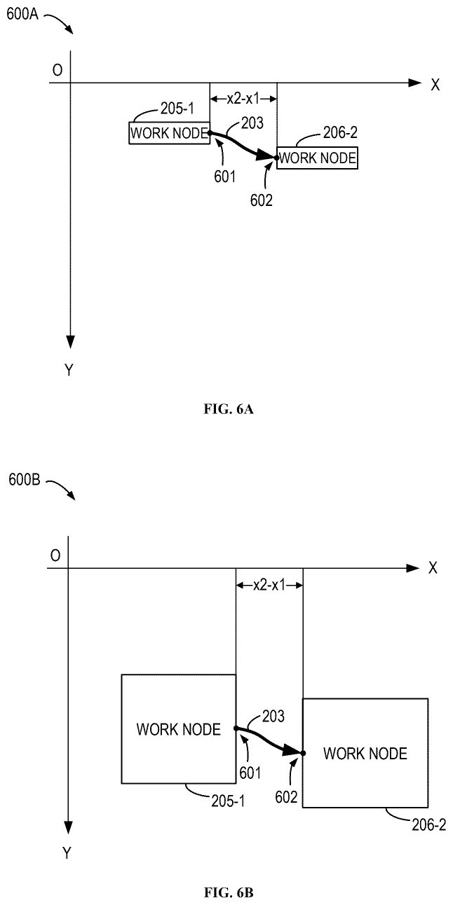

As an example, the terminal device 110 may maintain the relative positioning between the start point and the end point of the connection line 203 unchanged before and after the switching by controlling the coordinates of the start point and the end point of the connection line 203. FIG. 6A shows a schematic diagram of an example 600A of the two work nodes 202 interconnected in a second layout pattern according to some embodiments of the present disclosure. FIG. 6B shows a schematic diagram of an example 600B of the two work nodes 202 interconnected in a first layout pattern according to some embodiments of the present disclosure. In FIGS. 6A and 6B, a rectangular coordinate system including an X-axis, a Y-axis, and an origin O is shown, and the rectangular coordinate system is configured to indicate a relative positioning between the two work nodes 202 before and after the switching. It would be noted that, for clarity, in FIG. 6A and FIG. 6B, the two interconnected work nodes 202 are shown as the work node 202-5 and the work node 202-6. However, in the embodiments of the present disclosure, the two interconnected work nodes 202 may be any two work nodes 202 connected together by the connection lines 203, which is not limited in the embodiments of the present disclosure.

For clarity, the process of controlling the relative positioning between the start point and the end point of the connection line 203 in the embodiments of the present disclosure would be described below with reference to FIG. 6A and FIG. 6B by taking the work node 202-5 and the work node 202-6 as an example. It would be appreciated that the processes described below may be applicable to any two work nodes 202 connected together by the connection line 203.

As an example, for the interconnected the work node 202-5 and the work node 202-6, a start point 601 of the connection line 203 may refer to a position where the connection line 203 connects with an upstream work node (e.g., the work node 202-5) in the work node 202-5 and the work node 202-6. An end point 602 of the connection line 203 may refer to a position where the connection line 203 is connected to a downstream work node (for example, the work node 202-6) in the work node 202-5 and the work node 202-6.

As an example, the position where the connection line 203 is connected to the work node 202 may be any suitable position on the work node 202. For example, in FIG. 6A and FIG. 6B, a position where the connection line 203 is connected to the work node 202 is shown as a midpoint in a side of the work node 202 adjacent to the connection line 203. Specifically, the connection line 203 is connected to the middle point of the right side of the work node 202-5, and the connection line 203 is connected to the midpoint of the left side of the work node 202-6.

As an example, in a layout pattern before switching (for example, the second layout pattern), the terminal device 110 may obtain a coordinate (x1, y1) of the start point 601 of the connection line 203 and a coordinate (x2, y2) of the end point 602. Then, the terminal device 110 calculates a difference xδ1=x2−x1 between the horizontal coordinates of the start point 601 and the end point 602. After switching to the new layout pattern (e.g., the first layout pattern), regardless of the size of the work nodes 202-5 and 202-6, the terminal device 110 controls the difference between the new horizontal coordinates between the start point 601 and the end point 602 of the connection line 203 by xδ2=x2−x1. In this way, the horizontal distance between the start point 601 and the end point 602 of the connection line 203 before and after switching of the layout pattern may maintain unchanged. In addition, the terminal device 110 may further control, in a manner similar to the foregoing manner, that a difference between a new vertical coordinate between the start point 601 and the end point 602 of the connection line 203 maintains unchanged, so that the vertical distance between the start point 601 and the end point 602 of the connection line 203 before and after the layout pattern switching maintains unchanged. Therefore, the terminal device 110 may control the relative positioning of the start point 601 and the end point 602 of the connection line 203 before and after the layout pattern switch to maintain unchanged.

In some cases, the user 140 may manually edit the position of the work node 202 in the node graph 201. This results in the position of the work node 202 after editing by the user 140 may not be optimal. Alternatively, after switching the layout pattern, the parallel (e.g., no connected) work nodes 202 overlap due to the change in size of the work nodes 202. To address this, in some embodiments, in response to receiving the automatic layout indication for the node diagram 201, the terminal device 110 determines a recommended layout for the at least one the work node 202 based on at least the connection relationship between the at least one the work node 202, where the recommended layout indicates a position of the at least one the work node 202 in the page 150. Then, the terminal device 110 rearranges the at least one the work node 202 based on the recommended layout.

Referring back to FIGS. 2 and 4, the terminal device 110 may present an automatic layout control 207 on the page 150. The user 140 may trigger an automatic layout indication by operating the automatic layout control 207. After receiving the automatic layout indication, the terminal device 110 may analyze the connection relationship between the work nodes 202 in the node graph 201, and then determine a recommended layout based on the analysis of the connection relationship between the work nodes 202.

As an example, when determining the recommended layout, the terminal device 110 may consider a plurality of factors, and these factors may be set according to actual needs. For example, in order to maintain the clarity and ease of understanding of the node diagram 201, when determining the recommended layout, the terminal device 110 may consider as much as possible to shorten the connection line 203, and avoid the connection line 203 from crossing or overlapping. For another example, in order to balance the overall balance of the page 150, when determining the recommended layout, the terminal device 110 may consider that the work node 202 on the page 150 is distributed appropriately, thereby avoiding excessively congested areas.

As an example, regardless of which layout pattern the node diagram 201 is in, the terminal device 110 may provide an automatic layout capability. In this way, in the layout patterns, the user 140 may conveniently see the most ideal layout effect of the node diagram 201.

In some embodiments, the terminal device 110 determines an adjustment to a position of one or more work nodes 202 in the at least one work node 202 by reducing an overlapping part between the information presentation area 304 and the connection line 203 of the at least one work node 202 respectively. The terminal device 110 then generates the recommended layout based on the determined adjustment.

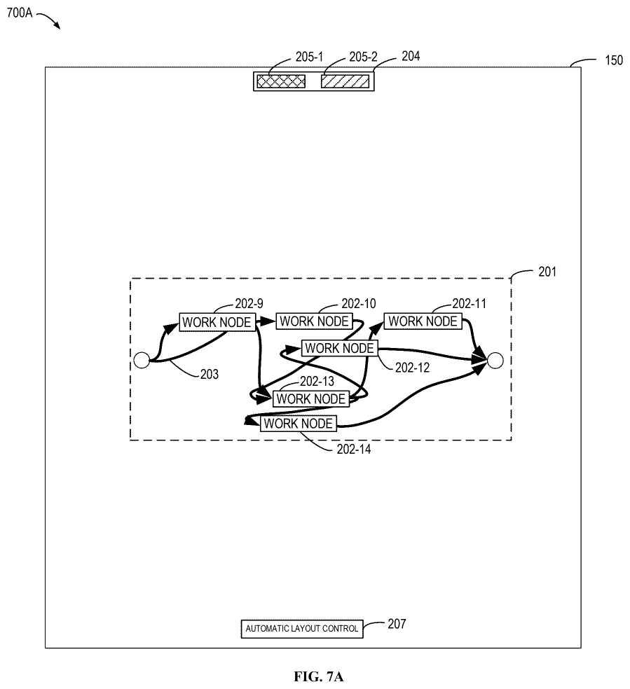

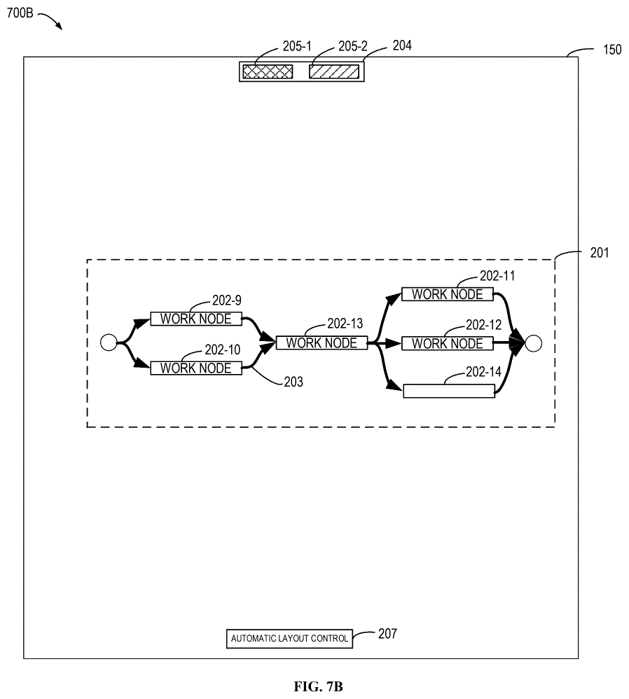

FIG. 7A shows a schematic diagram of an example 700A of a plurality of work nodes 202 before automatic layout in a second layout pattern according to some embodiments of the present disclosure. FIG. 7B shows a schematic diagram of an example 700B of a plurality of work nodes 202 after automatic layout in a second layout pattern according to some embodiments of the present disclosure. It would be noted that, for clarity, FIG. 7A and FIG. 7B only show the work nodes 202-9 to 202-14 in the plurality of work nodes 202-1, 202-2, 202-3, 202-4, . . . , 202-N·However, in the embodiments of the present disclosure, the plurality of work nodes 202 capable of being automatically laid out are not limited thereto, and the plurality of work nodes 202 capable of being automatically laid out may be any of the plurality of work nodes 202-1, 202-2, 202-3, 202-4, . . . , 202-N.

Referring to FIG. 7A, the user 140 manually edits the positions of the work nodes 202-9 to 202-14 in the node diagram 201, so that the connection lines 203 between the work nodes 202-9 to 202-14 cross each other, and the arrangement is chaotic. User 140 may trigger an automatic layout indication by clicking on the automatic layout control 207. In response to receiving the automatic layout indication, the terminal device 110 may determine an adjustment to a position of the work nodes 202-9 to 202-14 by reducing an overlapping part of the connection lines 203 connected between the work nodes 202-9 to 202-14, and further generate a recommended layout based on the determined adjustment. Once the recommended layout is determined, the terminal device 110 may rearrange the at least one the work node 202 based on the recommended layout, to obtain the arrangement result as shown in FIG. 7B.

As may be apparent from FIG. 7A and FIG. 7B, after the automatic layout, the overlapping parts of the connection lines 203 between the work nodes 202-9 to 202-14 are reduced, and the arrangement of the work nodes 202-9 to 202-14 becomes clear.

In some scenarios, the information presentation areas 304 corresponding to the work nodes 202-9 to 202-14 may overlap. For example, after obtaining the work nodes 202-9 to 202-14 as shown in FIG. 7B, the user 140 may switch from the second layout pattern to the first layout pattern through the layout pattern switching control 204. At this time, since the size of the work nodes 202-9 to 202-14 changes, the parallel work nodes 202 (e.g., the work nodes 202 without the connection relationship) may overlap.

In view of this, when determining the recommended layout, in addition to reducing the overlapping part of the connection lines 203, the overlapping parts between the information presentation areas 304 corresponding to the work nodes 202-9 to 202-14 may be reduced.

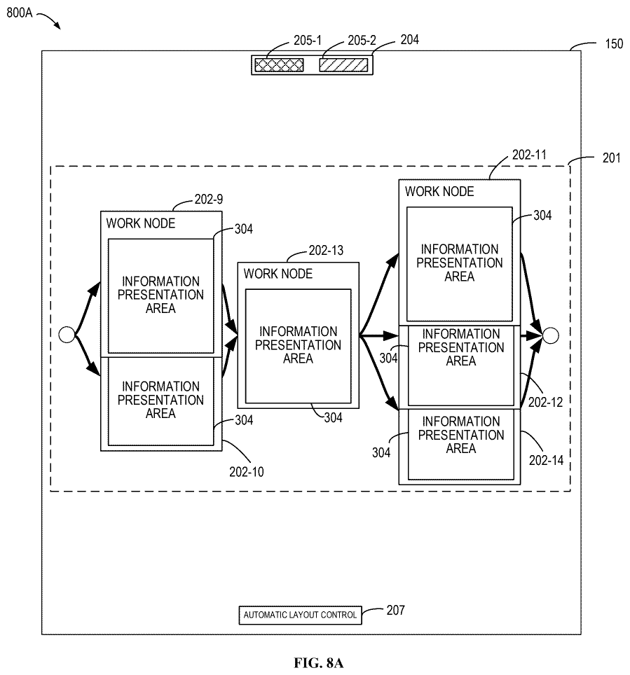

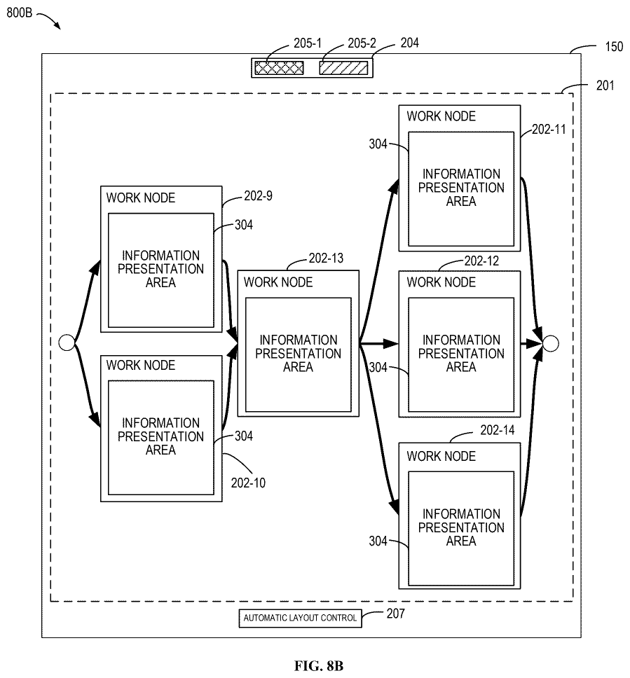

FIG. 8A shows a schematic diagram of an example 800A of a plurality of work nodes 202 before automatic layout in a first layout pattern according to some embodiments of the present disclosure. FIG. 8B shows a schematic diagram of an example 800B of a plurality of work nodes 202 after automatic layout in a first layout pattern according to some embodiments of the present disclosure. It would be noted that, for clarity, FIG. 8A and FIG. 8B only show the work nodes 202-9 to 202-14 in the plurality of work nodes 202-1, 202-2, 202-3, 202-4, . . . , 202-N. However, in the embodiments of the present disclosure, the plurality of work nodes 202 capable of being automatically laid out are not limited thereto, and the plurality of work nodes 202 capable of being automatically laid out may be any one of the plurality of work nodes 202-1, 202-2, 202-3, 202-4, . . . , 202-N.

With reference to FIG. 7B and FIG. 8A, after switching from the second layout pattern to the first layout pattern, the information presentation areas 304 corresponding to the work nodes 202-9 and 202-10 overlap, and the information presentation areas 304 corresponding to the work nodes 202-11, 202-12 and 202-14 also overlap. The user 140 may trigger an automatic layout indication by clicking on the automatic layout control 207. In response to receiving the automatic layout indication, the terminal device 110 may determine an adjustment to a position of the work nodes 202-9 to 202-14 by reducing an overlapping part between the information presentation areas 304 corresponding to the work nodes 202-9 to 202-14, and further generate a recommended layout based on the determined adjustment. Once the recommended layout is determined, the terminal device 110 may rearrange the at least one the work node 202 based on the recommended layout, to obtain the arrangement result as shown in FIG. 8B.

As may be clearly seen from FIG. 8A and FIG. 8B, after the automatic layout, the overlapping parts of the information presentation areas 304 corresponding to the work nodes 202-9 to 202-14 are reduced, and the information presentation areas 304 corresponding to the work nodes 202-9 to 202-14 are no longer blocked.

In this way, the terminal device 110 may generate a recommended layout for the user 140 in each layout pattern, thereby providing a more convenient and efficient node graph interaction experience for the user 140.

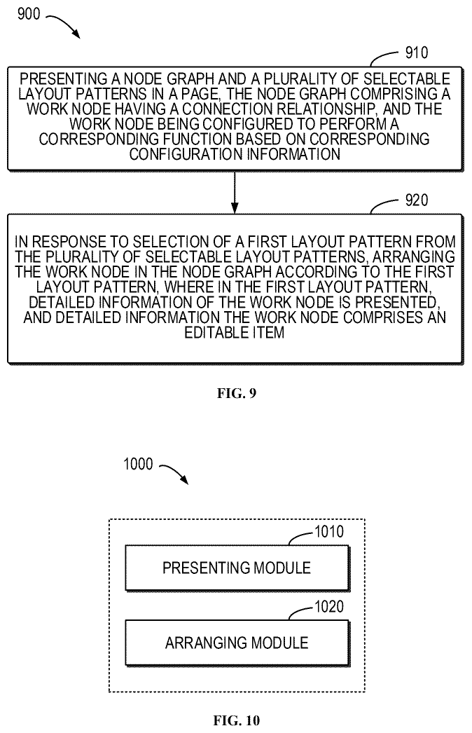

FIG. 9 shows a flowchart of an example process 900 for presenting a node graph according to some embodiments of the present disclosure. The example process 900 may be implemented at the terminal device 110. The example process 900 would be described below with reference to FIG. 1.

At block 910, the terminal device 110 presents a node graph and a plurality of selectable layout patterns on the page 150, the node graph including at least one work node having a connection relationship, and a work node in the at least one work node being configured to perform a corresponding function based on corresponding configuration information.

At block 920, the terminal device 110, in response to selection of a first layout pattern from the plurality of layout patterns, arranges the at least one work node of the node graph according to the first layout pattern, wherein in the first layout pattern, detailed information of the at least one work node is presented, and detailed information of one or more work nodes of the at least one work node includes at least one editable item.

In some embodiments, in the first layout pattern, for a given work node of the at least one work node, the terminal device 110, in response to receiving an edit operation on an editable item of the given work node, updates detailed information of the given work node based on the edit operation. Then, the terminal device 110 presents the updated detailed information of the given work node.

In some embodiments, in the first layout pattern, the at least one work node is each configured with a corresponding information presentation area in which detailed information of the corresponding work node is presented. For a given work node in the at least one work node, the terminal device 110 determines a size of the information presentation area corresponding to the given work node based on at least one of the following: a presentation size requirement of the detailed information of the given work node, and an upper size limit of the information presentation area. The terminal device 110 then presents the detailed information of the given work node in the information presentation area with the determined size.

In some embodiments, the terminal device 110, in response to selection of a second layout pattern of the plurality of layout patterns, arranges the at least one work node of the node graph according to the second layout pattern, wherein in the second layout pattern, summary information of the at least one work node is presented.

In some embodiments, in the second layout pattern, for a given work node of the at least one work node, the terminal device 110 presents the detailed information of the given work node based on a predetermined operation on the summary information of the given work node.

In some embodiments, the terminal device 110 presents the detailed information of the given work node in a further area different from the presentation area of the node graph.

In some embodiments, the terminal device 110, in response to switching from one of the plurality of layout patterns to a further layout pattern, controls relative positioning between two work nodes interconnected in the node graph to maintain unchanged.

In some embodiments, the terminal device 110 determines a start point and an end point of a connection line between the two work nodes interconnected in the node graph before the switching. Then, the terminal device 110 controls relative positioning between the start point and the end point of the connection line to maintain unchanged after the switching, to maintain the relative positioning between the two work nodes interconnected in the node graph unchanged.

In some embodiments, in response to receiving an automatic layout indication for the node graph, the terminal device 110 determines a recommended layout for the at least one work node based at least on the connection relationship between the at least one work node, the recommended layout indicating a position of the at least one work node in the page 150. Then, the terminal device 110 rearranges the at least one work node based on the recommended layout.

In some embodiments, the terminal device 110 determines an adjustment to a position of one or more work nodes in the at least one work node by reducing an overlapping part between information presentation areas and a connection line of the at least one work node respectively. The terminal device 110 then generates the recommended layout based on the determined adjustment.

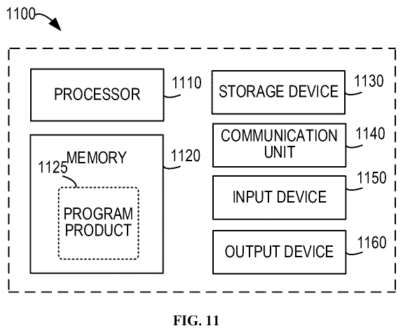

The embodiments of the present disclosure also provide a corresponding apparatus for implementing the above method or process. FIG. 10 shows a schematic structural block diagram of an apparatus 1000 for presenting a node graph according to some embodiments of the present disclosure. The apparatus 1000 may be implemented or included in the terminal device 110. The various modules/components in the apparatus 1000 may be implemented by hardware, software, firmware, or any combination thereof.

Referring to FIG. 10, the apparatus 1000 includes a presenting module 1010 and an arranging module 1020. The presenting module 1010 is configured to present a node graph and a plurality of selectable layout patterns in a page, the node graph including at least one work node having a connection relationship, and a work node in the at least one work node being configured to perform a corresponding function based on corresponding configuration information. The arranging module 1020 is configured to, in response to selection of a first layout pattern from the plurality of layout patterns, arrange the at least one work node of the node graph according to the first layout pattern, wherein in the first layout pattern, detailed information of the at least one work node is presented, and detailed information of one or more work nodes of the at least one work node includes at least one editable item.

In some embodiments, the apparatus 1000 further includes an updating module. The update module is configured to: in the first layout pattern, for a given work node of the at least one work node, in response to receiving an edit operation on an editable item of the given work node, update detailed information of the given work node based on the edit operation; and present the updated detailed information of the given work node.

In some embodiments, in the first layout pattern, the at least one work node is each configured with a corresponding information presentation area in which detailed information of the corresponding work node is presented, and the arranging module 1020 is further configured to: for a given work node of the at least one work node, determine a size of the information presentation area corresponding to the given work node based on at least one of the following: a presentation size requirement of the detailed information of the given work node, and an upper size limit of the information presentation area; and present the detailed information of the given work node in the information presentation area with the determined size.

In some embodiments, the arranging module 1020 is further configured to: in response to selection of a second layout pattern of the plurality of layout patterns, arrange the at least one work node of the node graph according to the second layout pattern, wherein in the second layout pattern, summary information of the at least one work node is presented.

In some embodiments, the apparatus 1000 further includes a detailed information presenting module configured to: in the second layout pattern, for a given work node of the at least one work node, present the detailed information of the given work node based on a predetermined operation on the summary information of the given work node.

In some embodiments, the detailed information presenting module is further configured to: present the detailed information of the given work node in a further area different from the presentation area of the node graph.

In some embodiments, the apparatus 1000 further includes a position maintaining module configured to: in response to switching from one of the plurality of layout patterns to a further layout pattern, control relative positioning between two work nodes interconnected in the node graph to maintain unchanged.

In some embodiments, the position maintaining module is further configured to: determine a start point and an end point of a connection line between the two work nodes interconnected in the node graph before the switching; and control relative positioning between the start point and the end point of the connection line to maintain unchanged after the switching, to maintain the relative positioning between the two work nodes interconnected in the node graph unchanged.

In some embodiments, the apparatus 1000 further includes a position automatic layout module configured to: in response to receiving an automatic layout indication for the node graph, determine a recommended layout for the at least one work node based at least on the connection relationship between the at least one work node, the recommended layout indicating a position of the at least one work node in the page; and rearrange the at least one work node based on the recommended layout.

In some embodiments, the automatic layout module is further configured to: determine an adjustment to a position of one or more work nodes in the at least one work node by reducing an overlapping part between information presentation areas and a connection line of the at least one work node respectively; and generate the recommended layout based on the determined adjustment.

FIG. 11 illustrates a block diagram of an electronic device 1100 in which one or more embodiments of the present disclosure may be implemented. The electronic device 1100 may, for example, be configured to implement the terminal device 110 as shown in FIG. 1. It would be understood that the electronic device 1100 illustrated in FIG. 11 is merely for example and would not constitute any limitation on the function and scope of the embodiments described herein.

As shown in FIG. 11, the electronic device 1100 is in a form of a general-purpose electronic device. Components of the electronic device 1100 may include, but are not limited to, one or more processors or processor 1110, memory 1120, storage device 1130, one or more communication units 1140, one or more input devices 1150, and one or more output devices 1160. The processor 1110 may be actual or virtual processors and are capable of performing various processes based on programs stored in the memory 1120. In a multiprocessor system, a plurality of processor performs computer-executable instructions in parallel to increase the parallel processing power of the electronic device 1100.

The electronic device 1100 typically includes a plurality of computer storage media. Such media may be any obtainable media accessible to the electronic device 1100, including, but not limited to, volatile and non-volatile media, removable and non-removable media. The memory 1120 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 1130 may be a removable or non-removable medium and may include a machine-readable medium, such as a flash drive, a disk, or any other medium that may be capable of being configured to store information and/or data and may be accessible within the electronic device 1100.

The electronic device 1100 may further include additional removable/non-removable, volatile/non-volatile storage media. Although not shown in FIG. 11, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 1120 may include a computer program product 1125 having one or more program modules that are configured to perform various methods or actions of various embodiments of the present disclosure.

The communication unit 1140 implements communication with other electronic devices via a communication medium. Additionally, the functions of the components of the electronic device 1100 may be implemented as a single computing cluster or a plurality of computing machines that are capable of communicating over a communication connection. Thus, the electronic device 1100 may use logical connections to one or more other servers, networked personal computers (PCs), or another network node to operate in a networked environment.

The input device 1150 may be one or more input devices, such as a mouse, a keyboard, a tracking ball, and the like. The output device 1160 may be one or more output devices, such as a monitor, a speaker, a printer, and the like. The electronic device 1100 may also communicate, as desired, via the communication unit 1140, with one or more external devices (not shown), external devices such as storage devices, display devices, etc., with one or more devices that enable a user to interact with the electronic device 1100, or with any device that enables the electronic device 1100 to communicate with one or more other electronic devices (e.g., a network card, modem, etc.) to communicate. Such communication may be performed via an input/output (I/O) interface (not shown).

According to an example implementation of the present disclosure, there is provided a computer-readable storage medium having computer-executable instructions stored thereon, wherein the computer-executable instructions are performed by a processor to implement the method described above. According to an example implementation of the present disclosure, there is also provided a computer program product, the computer program product being tangibly stored on a non-transient computer-readable medium and including computer-executable instructions, wherein the computer-executable instructions are performed by a processor to implement the methods described above.

Aspects of the present disclosure are described herein with reference to flowcharts and/or block diagrams of methods, apparatuses, devices, and computer program products implemented in accordance with the present disclosure. It would be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for presenting a node graph, comprising:
presenting a node graph and a plurality of selectable layout patterns in a page, the node graph comprising a work node having a connection relationship, and the work node being configured to perform a corresponding function based on corresponding configuration information; and
in response to selection of a first layout pattern from the plurality of selectable layout patterns, arranging the work node in the node graph according to the first layout pattern, wherein in the first layout pattern, detailed information of the work node is presented, and detailed information the work node comprises an editable item.

2. The method of claim 1, further comprising:
in the first layout pattern, for a given work node of the work node,
in response to receiving an edit operation on an editable item of the given work node, updating detailed information of the given work node based on the edit operation; and
presenting the updated detailed information of the given work node.

3. The method of claim 1, wherein in the first layout pattern, the work node is each configured with a corresponding information presentation area in which detailed information of the corresponding work node is presented, and wherein arranging the work node of the node graph in the first layout pattern comprises:
for a given work node of the work node,
determining a size of the information presentation area corresponding to the given work node based on at least one of the following: a presentation size requirement of the detailed information of the given work node, and an upper size limit of the information presentation area; and
presenting the detailed information of the given work node in the information presentation area with the determined size.

4. The method of claim 1, further comprising:
in response to selection of a second layout pattern of the plurality of layout patterns, arranging the work node of the node graph according to the second layout pattern, wherein in the second layout pattern, summary information of the work node is presented.

5. The method of claim 4, further comprising:
in the second layout pattern, for a given work node of the work node,
presenting the detailed information of the given work node based on a predetermined operation on the summary information of the given work node.

6. The method of claim 5, wherein presenting the detailed information of the given work node comprises:
presenting the detailed information of the given work node in a further area different from the presentation area of the node graph.

7. The method of claim 1, further comprising:
in response to switching from one of the plurality of layout patterns to a further layout pattern, controlling relative positioning between two work nodes interconnected in the node graph to maintain unchanged.

8. The method of claim 7, wherein controlling the relative positioning between the two work nodes interconnected in the node graph to maintain unchanged comprises:
determining a start point and an end point of a connection line between the two work nodes interconnected in the node graph before the switching; and
controlling relative positioning between the start point and the end point of the connection line to maintain unchanged after the switching, to maintain the relative positioning between the two work nodes interconnected in the node graph unchanged.

9. The method of claim 1, further comprising:
in response to receiving an automatic layout indication for the node graph, determining a recommended layout for the work node based at least on the connection relationship between the work node, the recommended layout indicating a position of the work node in the page; and
rearranging the work node based on the recommended layout.

10. The method of claim 9, wherein determining the recommended layout for the work node comprises:
determining an adjustment to a position of one or more work nodes in the work node by reducing an overlapping part between information presentation areas and a connection line of the work node respectively; and
generating the recommended layout based on the determined adjustment.

11. An electronic device, comprising:
at least one processor; and
at least one memory coupled to the at least one processor and storing instructions for execution by the at least one processor, the instructions, when executed by the at least one processor, causing the electronic device to perform acts comprising:
presenting a node graph and a plurality of selectable layout patterns in a page, the node graph comprising a work node having a connection relationship, and the work node being configured to perform a corresponding function based on corresponding configuration information; and
in response to selection of a first layout pattern from the plurality of selectable layout patterns, arranging the work node in the node graph according to the first layout pattern, wherein in the first layout pattern, detailed information of the work node is presented, and detailed information the work node comprises an editable item.

12. The electronic device of claim 11, wherein the acts further comprise:
in the first layout pattern, for a given work node of the work node,
in response to receiving an edit operation on an editable item of the given work node, updating detailed information of the given work node based on the edit operation; and
presenting the updated detailed information of the given work node.

13. The electronic device of claim 11, wherein in the first layout pattern, the work node is each configured with a corresponding information presentation area in which detailed information of the corresponding work node is presented, and wherein arranging the work node of the node graph in the first layout pattern comprises:
for a given work node of the work node,
determining a size of the information presentation area corresponding to the given work node based on at least one of the following: a presentation size requirement of the detailed information of the given work node, and an upper size limit of the information presentation area; and
presenting the detailed information of the given work node in the information presentation area with the determined size.

14. The electronic device of claim 11, wherein the acts further comprise:
in response to selection of a second layout pattern of the plurality of layout patterns, arranging the work node of the node graph according to the second layout pattern, wherein in the second layout pattern, summary information of the work node is presented.

15. The electronic device of claim 14, wherein the acts further comprise:
in the second layout pattern, for a given work node of the work node,
presenting the detailed information of the given work node based on a predetermined operation on the summary information of the given work node.

16. The electronic device of claim 15, wherein presenting the detailed information of the given work node comprises:
presenting the detailed information of the given work node in a further area different from the presentation area of the node graph.

17. The electronic device of claim 11, wherein the acts further comprise:
in response to switching from one of the plurality of layout patterns to a further layout pattern, controlling relative positioning between two work nodes interconnected in the node graph to maintain unchanged.

18. The electronic device of claim 17, wherein controlling the relative positioning between the two work nodes interconnected in the node graph to maintain unchanged comprises:
determining a start point and an end point of a connection line between the two work nodes interconnected in the node graph before the switching; and
controlling relative positioning between the start point and the end point of the connection line to maintain unchanged after the switching, to maintain the relative positioning between the two work nodes interconnected in the node graph unchanged.

19. The electronic device of claim 11, wherein the acts further comprise:
in response to receiving an automatic layout indication for the node graph, determining a recommended layout for the work node based at least on the connection relationship between the work node, the recommended layout indicating a position of the work node in the page; and
rearranging the work node based on the recommended layout.

20. A non-transitory computer-readable storage medium having computer-executable instructions stored thereon, the computer-executable instructions being executable by a processor to perform acts comprising:
presenting a node graph and a plurality of selectable layout patterns in a page, the node graph comprising a work node having a connection relationship, and the work node being configured to perform a corresponding function based on corresponding configuration information; and
in response to selection of a first layout pattern from the plurality of selectable layout patterns, arranging the work node in the node graph according to the first layout pattern, wherein in the first layout pattern, detailed information of the work node is presented, and detailed information the work node comprises an editable item.
